(19) United States
(12) Patent Application Publication
(10) Pub. No.: US 2013/0301031 A1
(43) Pub. Date: Nov. 14, 2013

(54) TEMPLATES FOR OPTICAL SHAPE SENSING CALIBRATION DURING CLINICAL USE

(71) Applicants: Robert Manzke, Sleepy Hollow, NY (US); Bharat Ramachandran, Morganville, NJ (US); Gert Wim 'T Hooft, Eindhoven (NL); Adrien Emmanuel Desjardins, Waterloo (CA); Heinrich Von Busch, Aachen (DE); Raymond Chan, San Diego, CA (US)

(72) Inventors: Robert Manzke, Sleepy Hollow, NY (US); Bharat Ramachandran, Morganville, NJ (US); Gert Wim 'T Hooft, Eindhoven (NL); Adrien Emmanuel Desjardins, Waterloo (CA); Heinrich Von Busch, Aachen (DE); Raymond Chan, San Diego, CA (US)

(73) Assignee: KONINKLIJKE PHILIPS N.V., EINDHOVEN (NL)

(21) Appl. No.: 13/981,093

(22) PCT Filed: Jan. 18, 2012
(86) PCT No.: PCT/IB2012/050246

§ 371 Date: Jul. 23, 2013

Related U.S. Application Data
(60) Provisional application No. 61/436,690, filed on Jan. 27, 2011.

(51) Int. Cl. G01L 1/24

(52) U.S. Cl. CPC G01L 1/242
USPC 356/32

(57) ABSTRACT

A medical device calibration apparatus, system and method include a calibration template (202) configured to position an optical shape sensing enabled interventional instrument (102). A set geometric configuration (206) is formed in or on the template to maintain the instrument in a set geometric configuration within an environment where the instrument is to be deployed. When the instrument is placed in the set geometric configuration, the instrument is calibrated for a medical procedure.

This disclosure relates to instrument calibration, and more particularly to a device, system and method for calibrating an instrument for optical fiber sensing.

Shape sensing based on fiber optics equates to distributed strain measurement in optical fibers with characteristic Rayleigh scatter patterns. Rayleigh scatter occurs as a result of random fluctuations of the index of refraction in the fiber core, inherent to the fiber manufacturing process. These random fluctuations can also be modeled as a Bragg grating with a random variation of amplitude and phase along the grating length. If strain or temperature change is applied to the optical fiber, the characteristic Rayleigh scatter pattern changes. An optical measurement can be performed first with no strain/temperature stimulus applied to the fiber to produce a reference scatter pattern and then again after induction of strain/temperature. Cross-correlation of the Rayleigh scatter spectra of the fiber in the strained/untrained states determines the spectral shift resulting from the applied strain. This wavelength Δλ, or frequency shift Δv of the backscattered pattern due to temperature change ΔT or strain along the fiber axis ε is very similar to the response of a fiber Bragg grating:

$$\frac{Δ λ}{λ} = - \frac{Δ v}{v} = {K}_{T} Δ T + {K}_{ɛ} ɛ ,$$

where the temperature coefficient K_{T} is the sum of the thermal expansion and thermo-optic coefficient. The strain coefficient K_{ε} is a function of group index n, the components of the strain optic tensor p_{i,j} and Poisson's ratio:

$${K}_{ɛ} = 1 - \frac{{n}_{eff}^{2}}{2 ( {p}_{12} - v ( {p}_{11} + {p}_{12} ) )} .$$

Thus, a shift in temperature or strain is merely a linear scaling of the spectral wavelength shift Δλ.

Optical Frequency Domain Reflectometry (OFDR) essentially performs frequency encoding of spatial locations along the fiber which enables distributed sensing of local Rayleigh reflection patterns. In OFDR, the laser wavelength or optical frequency is linearly modulated over time. For coherent detection, the backscattered wave is mixed with a coherence reference wave at the detector. The detector receives a modulated signal owing to the change of constructive to destructive interference and vice versa while scanning the wavelength. Its frequency Ω marks the position s on the fiber and its amplitude is proportional to the local backscattering factor and the total amplitude attenuation factor of forward plus backward propagation through the distance s. By performing a Fourier transform of the detector signal using, for example, a spectrum analyzer, this method permits for simultaneous recovery of the backscattered waves from all points s along the fiber. Thus, strain on different portions of the fiber can be determined by measuring spectral shifts of the characteristic Rayleigh scattering pattern using any number of shift-detection or pattern-matching methods (e.g. block-matching with cross-correlation or other similarity metric, computation of signal phase change, etc.) in combination with OFDR.

A shape sensing device can be built using the above distributed strain measurement methodology when either two or more optical fibers are in a known spatial relationship such as when integrated in a multi-core shape sensing fiber. Based on a reference shape or location with reference Rayleigh scatter patterns (or reference strains) new shapes can be reconstructed using relative strains between fibers in a known/given/fixed spatial relationship.

Fiber optic shape sensing (OSS) systems based on Rayleigh scattering depend on accurate determination of the scatter pattern in known preset positions. Viable calibration schemes are presently available that can simulate an optical bench-top in the experimental lab setting. However, no viable calibration schemes simulate an interventional environment and workflow.

In accordance with the present principles, a medical device calibration apparatus, system and method include a calibration template configured to position an optical shape sensing enabled interventional instrument. A set geometric configuration is formed in or on the template to maintain the instrument in a set geometric configuration within an environment where the instrument is to be deployed. When the instrument is placed in the set geometric configuration, the instrument is calibrated for a medical procedure.

A medical device calibration apparatus includes a calibration template configured to position an optical shape sensing enabled interventional instrument, and a set geometric configuration formed in or on the template to maintain the instrument in the set geometric configuration within an environment where the instrument is to be deployed such that when the instrument is placed in the set geometric configuration the instrument is calibrated for a medical procedure.

A method for calibrating a medical instrument includes providing a calibration template configured to position an optical shape sensing enabled interventional instrument; maintaining the instrument in a set geometric configuration relative to the calibration template and within an interventional environment where the instrument is to be deployed; and calibrating the medical instrument in the set geometric configuration using optical feedback from optical sensors in the instrument.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

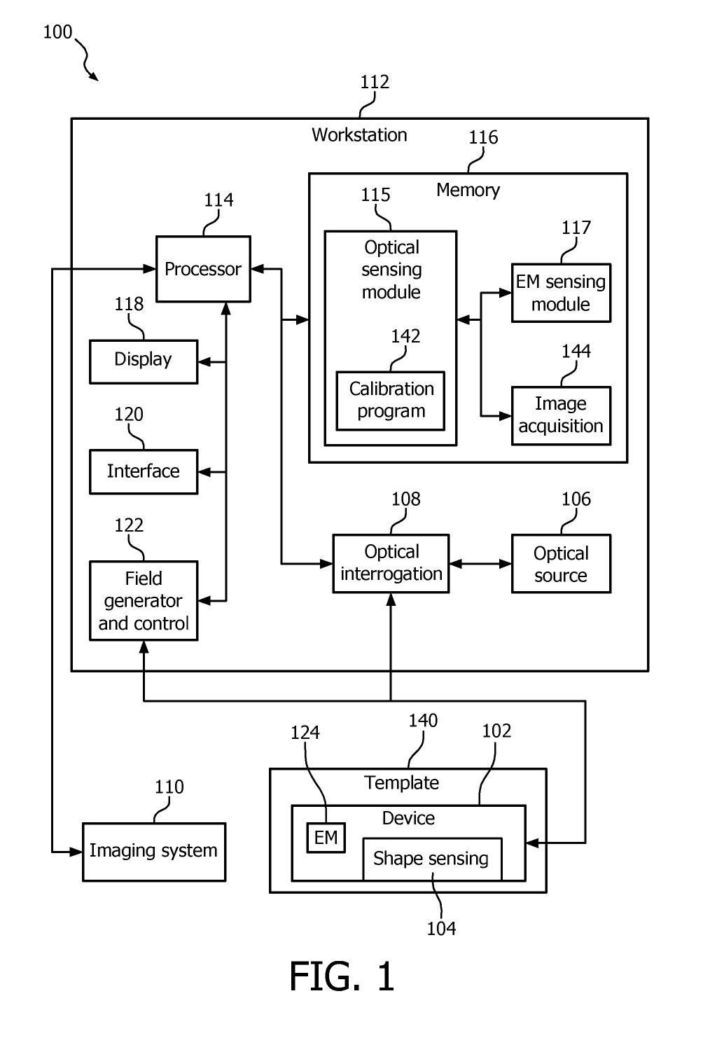

FIG. 1 is a block/flow diagram showing a system/method for calibrating an instrument having optical shape sensing with a calibration template in accordance with the present principles;

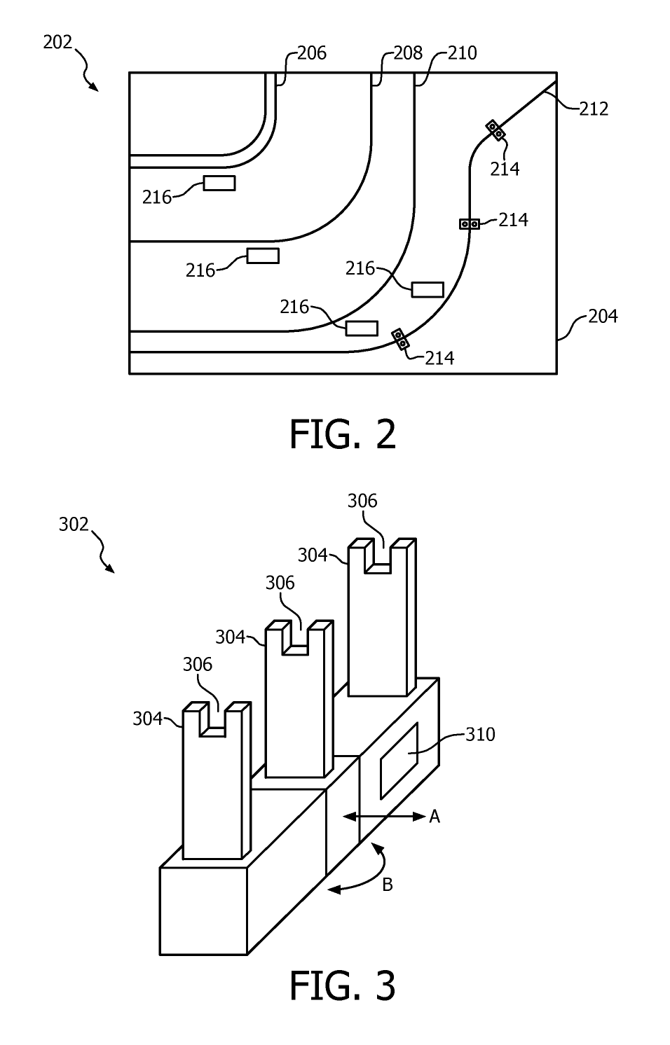

FIG. 2 is a view showing a template in the form of a sheet in accordance with one illustrative embodiment;

FIG. 3 is a perspective view showing a template in the form of a three-dimensional mechanism in accordance with another illustrative embodiment;

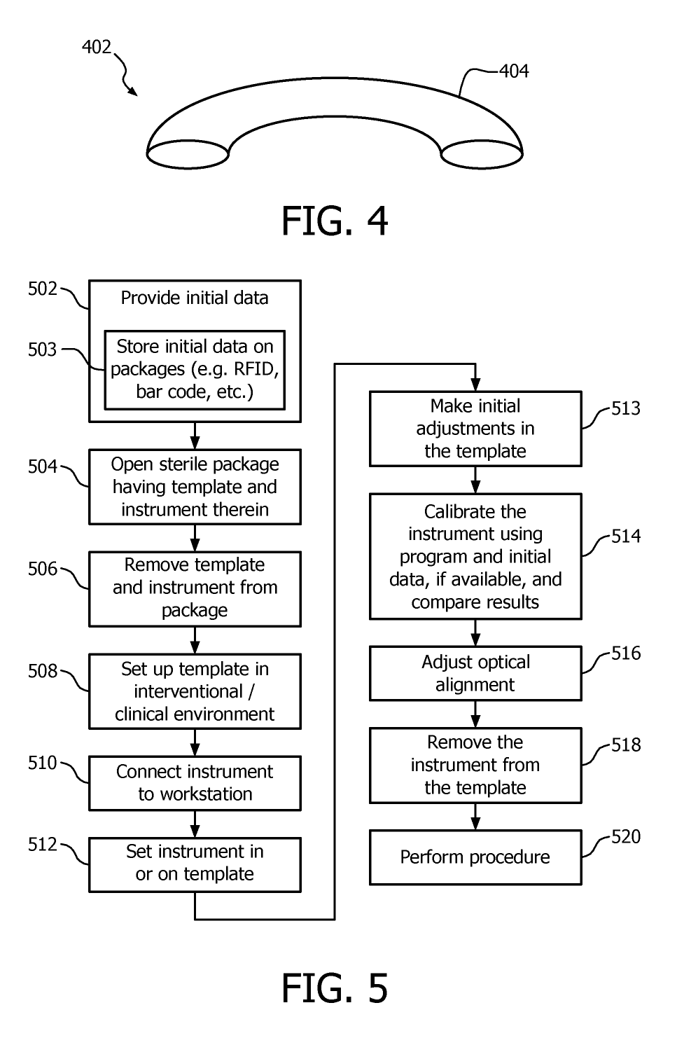

FIG. 4 is a perspective view showing a template in the form of a three-dimensional mechanism or tube in accordance with another illustrative embodiment; and

FIG. 5 is a block/flow diagram showing a system/method for calibrating an instrument having optical shape sensing using a calibration template in accordance with the present principles.

The present disclosure describes a device, system and method for calibrating an interventional instrument in an interventional environment and workflow. In one embodiment, a disposed template is provided for an instrument. The template may be packaged with the instrument or provided separately. The template is configured to secure the instrument in a predetermined geometric configuration within a clinical environment. In this geometric configuration, the instrument may be calibrated concurrently or in advance of a procedure.

In a particularly useful embodiment, the instrument includes a fiber optic shape sensing (OSS) system based on Rayleigh scattering. This instrument depends on accurate determination of a light scatter pattern in known preset positions, e.g., for a catheter or other elongated instrument. A scatter pattern for a particular shape or set of shapes is of interest during calibration. Calibration schemes using an optical bench-top in the experimental lab setting are not easily translated into a clinical setting. The present principles provide a template or templates (that may be disposable) to provide a viable calibration technique within the interventional environment and workflow. In particular, a disposable calibration template incorporated within the tracked device packaging for Rayleigh scatter-based shape sensing systems is provided.

It also should be understood that the present invention will be described in terms of medical instruments; however, the teachings of the present invention are much broader and are applicable to any instruments employed in tracking or analyzing complex biological or mechanical systems. In particular, the present principles are applicable to internal tracking procedures of biological systems, procedures in all areas of the body such as the lungs, gastro-intestinal tract, excretory organs, blood vessels, etc. The elements depicted in the FIGS. may be implemented in various combinations of hardware and software and provide functions which may be combined in a single element or multiple elements.

The functions of the various elements shown in the FIGS. can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), non-volatile storage, etc.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams and the like represent various processes which may be substantially represented in computer readable storage media and so executed by a computer or processor, whether or not such computer or processor is explicitly shown.

Furthermore, embodiments of the present invention can take the form of a computer program product accessible from a computer-usable or computer-readable storage medium providing program code for use by or in connection with a computer or any instruction execution system. For the purposes of this description, a computer-usable or computer readable storage medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Referring now to the drawings in which like numerals represent the same or similar elements and initially to FIG. 1, a system 100 for performing a medical procedure is illustratively depicted. System 100 may include a workstation or console 112 from which a procedure is supervised and managed. Workstation 112 preferably includes one or more processors 114 and memory 116 for storing programs and applications. Memory 116 may store an optical sensing module 115 configured to interpret optical feedback signals from a shape sensing device 104. Optical sensing module 115 includes a calibration program 142, which when executed compares a given input signal to a stored calibration value. Optical sensing module 115 is also configured to use the optical signal feedback (and any other feedback, e.g., electromagnetic (EM) tracking) to reconstruct deformations, deflections and other changes associated with a medical device 102 and/or its surrounding region. The calibration program 142 compares the instrument data (collected or input) with stored data (collected or input). The medical device 102 may include a catheter, a guidewire, a probe, an endoscope, a robot or other active device, etc.

Workstation 112 may include a display 118 for viewing internal images of a subject or patient and may be employed during the calibration procedure of the instrument or medical device 102 if an imaging system 110 is employed. Imaging system 110 may include a magnetic resonance imaging (MRI) system, a fluoroscopy system, a computed tomography (CT) system, etc. Display 118 may also permit a user to interact with the workstation 112 and its components and functions. This is further facilitated by an interface 120 which may include a keyboard, mouse, a joystick or any other peripheral or control to permit user interaction with the workstation 112.

System 100 may include an electromagnetic (EM) tracking system which may be integrated with the workstation 112 or be a separate system. The EM tracking system includes an EM sensing module 117 used to interpret EM signals generated by the medical device 102 during a procedure. The medical device 102 includes one of more EM tracking sensors 124, which may be mounted to the device 102. A field generator and control module 122 may include one or more coils or other magnetic field generation sources employed in tracking applications.

The EM sensing module 117 and the optical sensing module 115 may be employed with an image acquisition module 144 to acquire and display internal images of a procedure or otherwise assist in tracking the activities of the procedure.

Workstation 112 includes an optical source 106 to provide optical fibers with light. An optical interrogation unit 108 is employed to send and detect light to/from all fibers. This permits the determination of strains or other parameters, which will be used to interpret the shape, orientation, etc. of the interventional device 102. The light signals will be employed as feedback (e.g., Raleigh scattering) to calibrate the device 102 or system 100.

Shape sensing device 104 may include one or more fibers which are configured for geometric detection during a procedure. In accordance with the present principles, a calibration template 140 is provided for use in calibrating the instrument 102 for shape tracking or other errors, such as backscatter corruption and error characterization.

Optical interrogation module 108 works with optical sensing module 115 (e.g., shape determination program) to determine a shape of the instrument or device 102. Measurement error and confidence intervals may determined using the template 140 to hold, maintain or guide the instrument 102 in a fixed geometry to produce data (e.g., scatter information) used to calibrate the instrument.

In one embodiment, optical fiber shape sensing (OSS) enabled interventional devices such as catheters, ICE probes, scopes, robots, etc. may be packaged in accurate strain and torsion preset geometries using the template 140. The packaging may include a blister pack, a molded plastic or other materials, etc. The devices 102 can be mounted on, e.g., a disposable calibration template of known geometry within the sterile packaging and the calibration of the shape sensing instrument 102 can be performed while it is held fixed within the template 140. The template 140 may include a number of configurations, some or which may include a disposable sheet of paper or cardboard having geometric patterns (radii, etc.) for contorting the device for calibration, a stand or other mechanism having geometrically positioned hold positions for securing the device, a tube having a having geometrical positions for slidably securing the device, etc.

Referring to FIG. 2, a template 202 is shown in accordance with one illustrative embodiment. The template 202 includes a sheet 204, which may include paper, cardboard, plastic, etc. Sheet 204 includes set geometric patterns, which may include radii 206, 208 and 210, a serpentine pattern 212, or any other useful pattern. In one embodiment, the patterns may provide grooves to fit a particular instrument or fastening mechanisms 214 may be provided to hold portions of the instrument in place. Each pattern, groove, etc. may include a label 216 describing the pattern, groove, etc.

Referring to FIG. 3, another template 302 is shown in accordance with another illustrative embodiment. In this embodiment, a more complex template may be provided. In this example, the template 302 is three-dimensional and provides three positions 304 for securing a medical instrument with OSS capabilities. In this example, a center position is translatable (in the direction of arrow “A”) and rotatable (in the direction of arrow “B”). The instrument (not shown) may be secured at a top portion 306 of each position 304 and repositioned using the center position 304. Calibration may be run at each of a plurality of positions. It should be understood that in other embodiments, the center position may be fixed and one or more of the other positions may be moved. Any number of positions 304 may be employed and different translations and rotations may be imparted as needed. Note that other mechanisms are also contemplated.

In one embodiment, the template 302 may be part of the packaging of the medical device (102). The template 302 (and/or packaging) may include a bar code or radio frequency identification tag 310 with initial calibration data stored therein, which may be employed in calibrating the device (102).

Referring to FIG. 4, another template 402 is shown in accordance with another illustrative embodiment. Template 402 includes a semi-toroid 404. An instrument (not shown) may be inserted into the tube 404 to provide a desired shape. The tube 404 may be configured to provide any number of configurations and may be transparent to observe the instrument configuration.

In preferred embodiments, the packaging of OSS enabled interventional device (102) includes a template (140). The device can be mounted on a disposable calibration template of known geometry within the sterile packaging. The calibration of the shape sensing instrument (102) can be performed while it is held fixed within the template inside or outside of the packaging.

Referring to FIG. 5, a method for calibrating an OSS instrument in a clinical environment is illustratively shown. In block 502, calibration information and conditions are provided for the instrument. This may include written data such as an optical loss or scatter information (in dB) for a given condition (a radius of X cm). In one embodiment, data describing the geometry of the calibration template could be read from a bar code or other means on the packaging that is scanned by a user in block 503. This may be employed as a link to a full geometry data record stored in a software database. In another embodiment, radio frequency identification (RFID) tags may be employed to communicate the data.

In block 504, a sterile package from which the OSS instrument is packaged is opened. In block 506, the calibration template and tracked device assembly are removed from the package. In block 508, the template is set up docked or positioned within the interventional or clinical setting, e.g., on or at a predefined position on the X-ray table or other platform. In block 510, a device connector is coupled to a console or workstation (see FIG. 1).

In block 512, the instrument or device is set in the calibration template. In one embodiment, the calibration template is configured to provide a condition employed to obtain the initial data (from block 502). In block 513, initial adjustments may be made to the instrument in the template. A path for the instrument provided by the template can be designed in a way that torsion of non-geometric origin is eliminated (e.g., using grooves, notches, etc.).

In block 514, a calibration program is executed while the instrument is held within the calibration template in a fixed geometry (e.g., a predefined straight path, known curvature, etc.). The calibration may be employed to compare measured data with the initial data or previously collected data. The calibration yields differences between the initial data and the presently measured instrument configuration in the calibration template in the clinical environment. The differences may be employed to provide data offsets or corrections, indicate that the device needs to be further checked, indicate other issues, etc.

In block 516, based on a measured interference signal in the preset position, optical alignment is adjusted using, e.g., motorized controllers, actuated members, etc. by the optical interrogation system (see FIG. 1). Other adjustments may also be made to the instrument in the template for calibration or recalibration.

In block 518, the device is readied for clinical use by removing the device from the calibration template. In block 520, the interventional procedure is carried out.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for devices, systems and methods for optical shape sensing calibration templates for clinical use (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims. Having thus described the details and particularity required by the patent laws, what is claimed and desired protected by Letters Patent is set forth in the appended claims.

1. A calibration system for a medical instrument, comprising:
a calibration template (140) configured to position an optical shape sensing enabled interventional instrument (102) and set the instrument in a set geometric configuration within an environment where the instrument is to be deployed;
an optical interrogation module (108) configured to collect optical feedback from the instrument in the calibration template; and
a calibration program (142) stored in memory and executed by a processor to compare the optical feedback with calibration data.

2. (canceled)

3. The system as recited in claim 1, wherein the calibration template (140) includes a sheet (202) having one of more calibration patterns (206) to provide the set geometric configuration of the instrument, the one of more calibration patterns including a groove for securing the instrument in the set geometric configuration.

4. The system as recited in claim 1, wherein the calibration template (140) includes a sheet (202) having one of more calibration patterns (206) to provide the set geometric configuration of the instrument, the one of more calibration patterns including a fastening mechanism (214) for securing the instrument in the set geometric configuration.

5. (canceled)

6. The system as recited in claim 1, wherein the calibration template (140) includes a three-dimensional mechanism (302) to provide the set geometric configuration of the instrument, the three-dimensional mechanism including molded packaging.

7. The system as recited in claim 1, wherein the calibration template (140) includes a three-dimensional mechanism (302) to provide the set geometric configuration of the instrument, the three-dimensional mechanism including position points (304) to secure the instrument along a longitudinal axis.

8. The system as recited in claim 7, wherein at least one of the position points (304) is moveable to reposition the instrument along the longitudinal axis.

9. (canceled)

10. (canceled)

11. (canceled)

12. (canceled)

13. A medical device calibration apparatus, comprising:
a calibration template (202) configured to position an optical shape sensing enabled interventional instrument (102); and
a set geometric configuration (206) formed in or on the template to maintain the instrument in the set geometric configuration within an environment where the instrument is to be deployed such that when the instrument is placed in the set geometric configuration the instrument is calibrated for a medical procedure by comparing optical feedback from the optical shape sensing enabled interventional instrument with calibration data.

14. (canceled)

15. The device as recited in claim 13, wherein the calibration template (202) includes a sheet and the set geometric configuration includes one of more calibration patterns, the one of more calibration patterns including a groove for securing the instrument.

16. The device as recited in claim 13, wherein the calibration template (202) includes a sheet and the set geometric configuration includes one of more calibration patterns, the one of more calibration patterns including a fastening mechanism (214) for securing the instrument.

17. (canceled)

18. The device as recited in claim 13, wherein the calibration template (302) includes a three-dimensional mechanism to provide the set geometric configuration of the instrument, the three-dimensional mechanism including molded packaging.

19. The device as recited in claim 13, wherein the calibration template (302) includes a three-dimensional mechanism to provide the set geometric configuration of the instrument, the three-dimensional mechanism including position points (304) to secure the instrument along a longitudinal axis.

20. The device as recited in claim 19, wherein at least one of the position points (304) is moveable to reposition the instrument along the longitudinal axis.

21. (canceled)

22. (canceled)

23. (canceled)

24. (canceled)

25. A method for calibrating a medical instrument, comprising:
providing (504) a calibration template configured to position an optical shape sensing enabled interventional instrument;
maintaining (512) the instrument in a set geometric configuration relative to the calibration template and within an interventional environment where the instrument is to be deployed; and
calibrating (514) the medical instrument in the set geometric configuration using optical feedback from optical sensors in the instrument.

26. (canceled)

27. The method as recited in claim 25, wherein the calibration template includes one of a sheet (202) with one of more calibration patterns, and a three-dimensional mechanism (302, 402) to provide the set geometric configuration of the instrument.

28. The method as recited in claim 27, wherein the three-dimensional mechanism includes position points (304) to secure the instrument along a longitudinal axis, wherein at least one of the position points is moveable to reposition the instrument along the longitudinal axis.

29. (canceled)

30. (canceled)
